(19) United States
(12) Patent Application Publication
(10) Pub. No.: US 2011/0078052 A1
(43) Pub. Date: Mar. 31, 2011

(54) VIRTUAL REALITY ECOMMERCE WITH LINKED USER AND AVATAR BENEFITS

(76) Inventor: Yunus Ciptawilangga, Bandung West Java (ID)

(21) Appl. No.: 12/942,584

(22) Filed: Nov. 9, 2010

Related U.S. Application Data
(63) Continuation-in-part of application No. 12/474,206, filed on May 28, 2009.
Application No. 12/474,206 is a continuation-in-part of application No. 12/474,202, filed on May 28, 2009.
Application No. 12/474,202 is a continuation-in-part of application No. 12/839,782, filed on Jul. 20, 2010.

(30) Foreign Application Priority Data
Jul. 27, 2009 (ID) C00200902897

(51) Int. Cl. G06Q 30/00

(52) U.S. Cl. 705/27.1

(57) ABSTRACT

An online virtual reality ecommerce system provides parallel, linked real and virtual products with parallel benefits to users and to their avatars, thereby increasing user-perceived linkage with their avatars, and increasing user motivation to engage in the ecommerce. Embodiments include linked purchases and deliveries of tangible goods, status goods, movies, fitness training, lectures, and travel. In some embodiments, services are delivered simultaneously to the avatar and to the user through the virtual reality world. Benefits to the user and to the avatar can include entertainment, enhanced status, enhanced health, enhanced employment opportunities, and travel to desired destinations.

### RELATED APPLICATIONS

This application is a continuation in part of U.S. application Ser. No. 12/474,206, filed on May 28, 2009, incorporated herein by reference in its entirety for all purposes. This application is also a continuation in part of U.S. application Ser. No. 12/474,202, also filed on May 28, 2009, incorporated herein by reference in its entirety for all purposes. This application is also a continuation in part of U.S. application Ser. No. 12/839,782, filed on Jul. 20, 2010, incorporated herein by reference in its entirety for all purposes. U.S. application Ser. No. 12/839,782 claims the benefit of Indonesian patent application C00200902897, filed on Jul. 27, 2009, incorporated herein by reference in its entirety for all purposes.

### FIELD OF THE INVENTION

The invention relates to online e-commerce systems, and more particularly to online virtual reality ecommerce systems.

### BACKGROUND OF THE INVENTION

Online, internet-accessible “virtual reality worlds” have become increasingly popular, as personal computers have grown in power and become widely affordable, and high-speed internet access has become commonplace. Online virtual reality worlds can provide to an internet user an illusion of exploring, interacting with, and generally existing in a computer-generated world which mimics the real world in many ways. Internet-accessible virtual reality worlds are typically hosted by one or more internet servers, and can be accessed over the internet using almost any internet-capable device, such as a personal computer or a portable, hand-held, internet-capable device.

Typically, a user interacts with a virtual reality world by controlling the actions of a virtual being, also known as an “avatar.” In many virtual reality worlds, avatars are able to mimic the actions of real people in a variety of ways, such as by looking in different directions, moving to different locations, entering buildings, handling objects, and even interacting with other avatars. Interactions between avatars can include speaking, showing facial expressions, and using movements to display a range of feelings and emotions, for example by drooping over to indicate illness, shedding tears to show sadness, and/or jumping around to show joy or excitement.

Generally, an avatar functions as an extension of its user, by going where the user directs, looking where the user wishes to look, and expressing emotions which reflect the emotions of the users. In this way, the user comes to view the avatar as an extension of himself or herself in the virtual world. Environments and experiences which are encountered by the avatar are experienced by the user almost as if they had happened directly to the user.

Note that some avatars appear to have male or female genders, while other avatars do not have obvious genders. For simplicity, neuter pronouns will be used herein to refer to avatars, regardless of their apparent gender.

Ecommerce is frequently included in online virtual reality worlds, whereby an avatar (and thereby a user) examines and purchases a virtual representation of a real item, after which a corresponding real item is shipped to the user in the real world. This approach enables a user to enjoy a simulated “real-world” shopping experience without having to leave the comfort of home. Some virtual reality worlds even provide virtual retail locations, where an avatar controlled by a consumer can interact with an avatar controlled by a vendor salesman, thereby simulating an interaction between a customer and a retail salesperson in the real world. The two avatars can exchange information regarding products for sale, consider options, and complete a purchase transaction.

In addition to real items for direct use by the user, virtual items such as virtual clothing or virtual homes can sometimes be purchased for use by an avatar within the virtual world. And in some cases an intangible item, such as a lecture, a movie, a music concert, a horoscope, and such like, may be purchased in the virtual reality world and delivered to the user through the virtual reality world itself.

In general, it is the simulation of “real” life, or at least of an experience which “seems” real to a user, which motivates the user to spend time interacting with an online virtual reality world. Therefore, the more that a user comes to identify with his or her avatar, and the more that the user feels as if the circumstances and experiences of the avatar are part of his or her own experiences, the more motivated the user will be to spend time and carry out activities in the virtual world. And of course, the more motivated a user is to spend time in a virtual world, the more likely the user will be to engage in e-commerce within the virtual world.

What is needed, therefore, is an online virtual reality ecommerce system which is based on a virtual reality world having enhanced features that strengthen a user's identification with his or her avatar, thereby strengthening the motivation of the user to spend time in the virtual reality world and to engage in ecommerce within the virtual reality world.

### SUMMARY OF THE INVENTION

The present invention is an online virtual reality ecommerce system based on a virtual reality world in which ecommerce transactions provide parallel, linked benefits to users and to their avatars, thereby increasing the user's perceived linkage with his or her avatar, and increasing the user's motivation to engage in ecommerce within the virtual reality world. In the ecommerce system of the present invention, an avatar not only explores a virtual reality world so as to enable a user to engage in ecommerce, the avatar also receives benefits from the ecommerce which correspond with and/or are parallel to the benefits received by the user, thereby enhancing the user's tendency to identify with the avatar and to feel projected into the virtual reality world. The result is increased user motivation to spend time in the virtual reality world and to engage in ecommerce within the virtual reality world.

In some embodiments, a purchase by an avatar of a virtual tangible good, such as an article of clothing, causes the virtual item to be provided to the avatar, and also causes a corresponding real-world item to be delivered to the user. In some of these embodiments, a purchase by the avatar of a product which carries a recognizable, status-enhancing brand or price causes the social status of the avatar to increase within the virtual reality world, as well as enhancing the status of the user in the real world.

In certain embodiments, purchase by the avatar of a service within the virtual reality world, such as a session with a personal trainer, causes the avatar to receive enhanced health and stamina, while at the same time the user receives personal fitness training, either by a fitness trainer in the real world or delivered online by a virtual fitness trainer. In still other embodiments, performance of a service by an avatar in the virtual world, such as working at a virtual job, cases the avatar to receive virtual wages, while at the same time the user receives real wages. And in some embodiments, procurement of educational instruction by an avatar within the virtual reality world, for example by paying to attend an online lecture or to take an online course, provides new knowledge and skills to the user, while at the same time providing new virtual skills and qualifications to the avatar, enabling the avatar to perform new tasks and/or to seek new employment which was not otherwise available to the avatar.

In some embodiments, avatars have needs which correspond at least approximately with the needs of the user. In some of these embodiments, avatars experience hunger if they do not obtain food, reduced health if they do not exercise, and/or reduced status if they do not possess appropriate belongings. In certain embodiments, both the user and the avatar may become bored and lose happiness if the user fails to purchase entertainment services, both the user and the avatar may have fewer successful social interactions if the user does not purchase status goods, and/or both the avatar and the user may experience decreased health and stamina if the user fails to purchase health-related services such as fitness training.

Various embodiments also provide locations in the virtual reality worlds which correspond with locations in the real world. In some of these embodiments purchase by the user of travel arrangements in the real world causes the avatar to be transported to the corresponding location in the virtual world. As a result, the user and the avatar not only can “live” together, they can also take business trips and vacations together, further enhancing the perception of the user that the experiences of the avatar are linked extensions and additions to the user's own personal experiences.

The present invention is an ecommerce system which includes media containing software which is operable on a server computer and accessible to a user through a computer network. The software is able to provide to the user a simulation of a virtual reality world, which includes an avatar under control of the user and a virtual product available for purchase by the avatar within the virtual reality world. Purchase of the virtual product by the avatar causes delivery of a linked real product to the user, the virtual product being at least a virtual representation of the linked real product.

In various embodiments, purchase of the virtual product by the avatar provides a benefit to the avatar, and the resulting delivery of the real product to the user provides a linked, corresponding benefit to the user.

In some embodiments, the virtual product is a tangible good, which is a virtual representation of the real product. In some of these embodiments, the real product is shipped to the user after the virtual product is purchased by the avatar. And in other of these embodiments purchase of the virtual product by the avatar causes a voucher to be provided to the user, the voucher being redeemable for the real product.

In certain embodiments, the virtual product enhances a status of the avatar, and the real product enhances a status of the user.

In various embodiments, the virtual product is a service which is delivered simultaneously through the virtual reality world to both the avatar and the user. And in some of these embodiments, the service includes a movie, a dramatic performance, a concert, a fitness training session, and/or a lecture.

In some embodiments, the avatar receives increased health due to purchase of the virtual product, and the user receives increased health due to consumption of the real product. In other embodiments, the avatar receives increased stamina due to the purchase of the virtual product, and the user receives increased stamina due to consumption of the real product.

In other embodiments, the avatar receives increased employment qualifications due to the purchase of the virtual product, and the user receives increased employment qualifications due to consumption of the real product.

In certain embodiments, the virtual product includes transportation to a virtual location within the virtual reality world, and the real product includes transportation to a real location in the real world. And in some of these embodiments, the virtual location is a virtual representation of the real location.

And in various embodiments, the virtual product meets a virtual need of the avatar, the virtual need corresponding to a real need of the user which is met by the real product.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a flow diagram which illustrates an embodiment of the ecommerce method of the present invention;

FIG. 2 is an illustration of an avatar shopping for a computer in an embodiment of the present invention;

FIG. 3 is an illustration of an avatar shopping for food in an embodiment of the present invention;

FIG. 4 is an illustration of an avatar listening to a lecture in an embodiment of the present invention;

FIG. 5 is an illustration of an avatar carrying a recently purchased status item in an embodiment of the present invention;

FIG. 6 is an illustration of an avatar receiving fitness instruction in an embodiment of the present invention;

FIG. 7 is an illustration of an avatar waiting to board a train in an embodiment of the present invention; and

FIG. 8 is an illustration of an avatar visiting a virtual representation of a real world location in an embodiment of the present invention,

### DETAILED DESCRIPTION

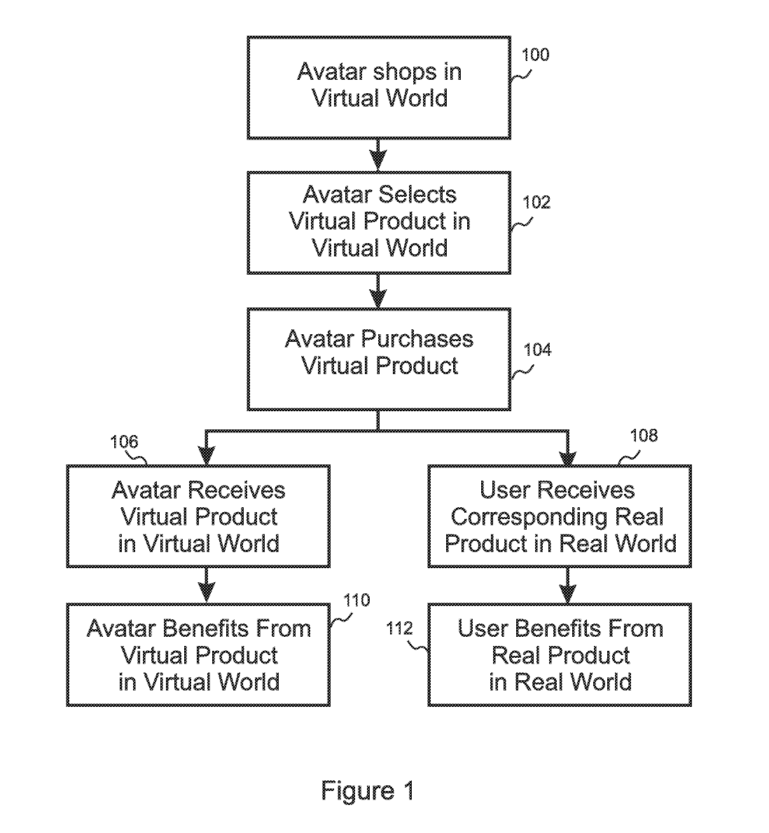

With reference to FIG. 1, the present invention is an online virtual reality ecommerce system based on a virtual reality world in which ecommerce transactions provide parallel, linked benefits to users and to their avatars, thereby increasing the user's perceived linkage between the avatar's experiences and his or her own experiences, and thereby increasing the user's motivation to engage in ecommerce within the virtual reality world.

The flow diagram of FIG. 1 illustrates an embodiment in which an avatar, controlled by a user, shops for products in the virtual reality world 100, where virtual representations of goods available for delivery in the real world are presented, explained, and/or demonstrated in the virtual reality world. Once the user has made a selection 102, he or she directs the avatar to complete a purchase within the virtual reality world 104. As a result, the avatar receives the virtual product for use in the virtual world 106, while a real product corresponding to the virtual product is shipped to the user in the real world 108. Or, if the product is a service such as a lecture, movie, or concert, the service may be delivered to both the avatar and to the user directly through the virtual reality world. Either way, both the avatar 110 and the user 112 receive parallel benefits from the purchase.

An ecommerce purchase according to the present invention therefore causes the user and the avatar to receive linked virtual and real world products, and to experience corresponding benefits therefrom. This direct linkage between the virtual reality world and the real world serves to enhance the realism of the virtual reality experience and to blur the boundary between them, thereby increasing the motivation of the user to spend time in the virtual reality world and to engage in ecommerce within the virtual reality world.

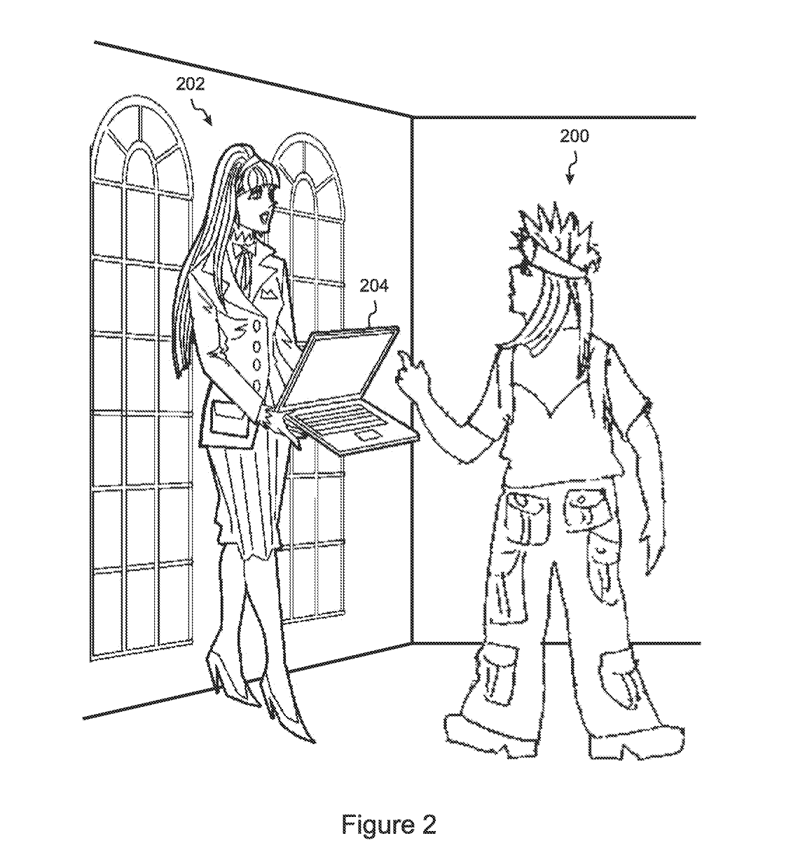

In various embodiments, an ecommerce purchase by an avatar 200 can be a purchase of a tangible, durable item such as an article of clothing or electronics. In FIG. 2, a user's avatar 200 is receiving information from a sales avatar 202 regarding a computer 204 which is being offered for sale. If the avatar 200 purchases the computer, the avatar will receive a virtual computer 204 as shown in the figure, and at the same time a real computer which corresponds to the virtual computer 204 will be shipped to the avatar's user. Depending on the features of the specific embodiment, the avatar may be able to use the virtual computer to access information within the virtual reality world which is not otherwise readily available. The user, of course, will be able to use the real-world computer for any computer enabled task, including connection to the virtual reality world.

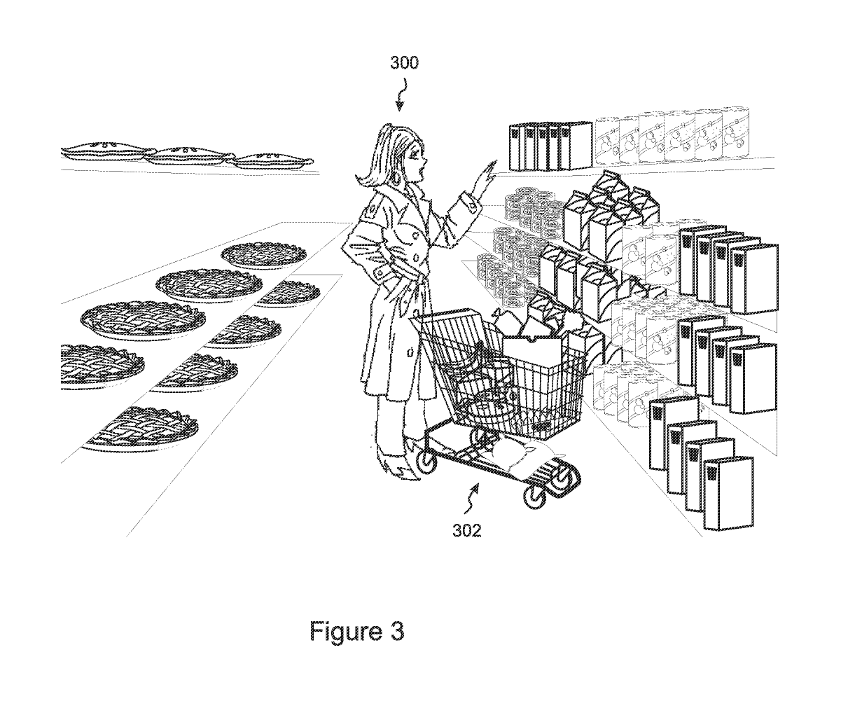

With reference to FIG. 3, in some embodiments avatars have needs which must be met, such as hunger, health, physical fitness, education, and so forth. In FIG. 3, an avatar 300 is purchasing food 302 in a virtual supermarket. In the embodiment of FIG. 3, the virtual food will be consumed by the avatar, and will serve to maintain the avatar's health and energy, and will keep the avatar from suffering due to hunger. In parallel, a coupon will be printed on the user's computer which can be exchanged by the user at a local real-world supermarket for food.

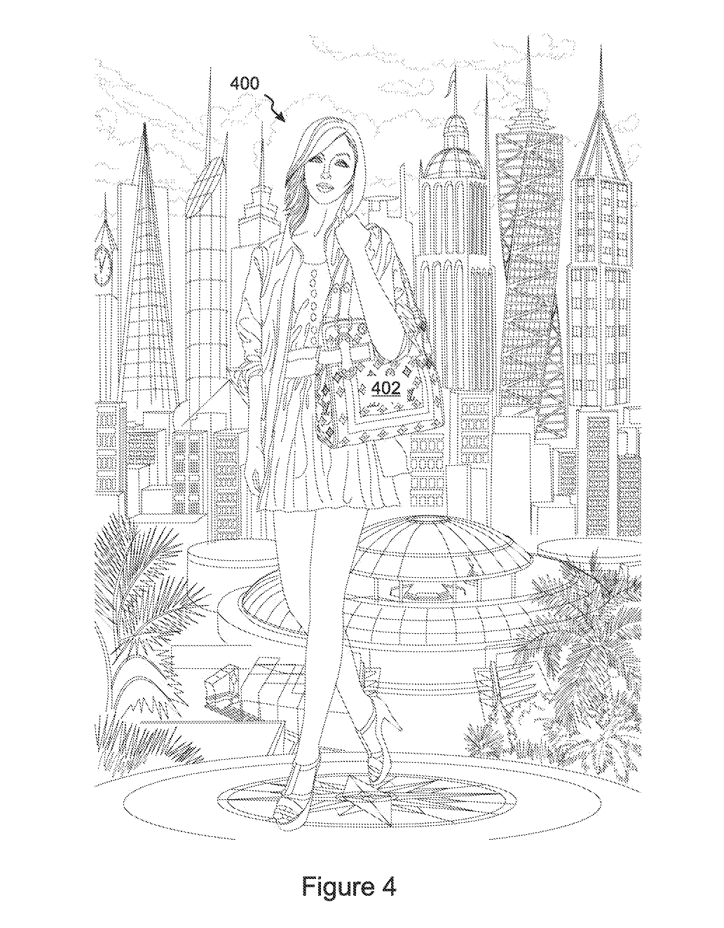

Many products including not only a utility value but also a status value. In FIG. 4, an avatar 400 is illustrated carrying a status purse 402 which the avatar 400 received due to an ecommerce purchase which also caused a corresponding real-world purse to be shipped to the user of the avatar. As a result, both the avatar and the user receive corresponding status benefits in their respective worlds. (Note that all intellectual property rights pertaining to the trademarks, service marks, graphics, and logos illustrated as part of the purse 402 shown in FIG. 4 are the property of Louis Vuitton Malletier, S.A., of Paris France).

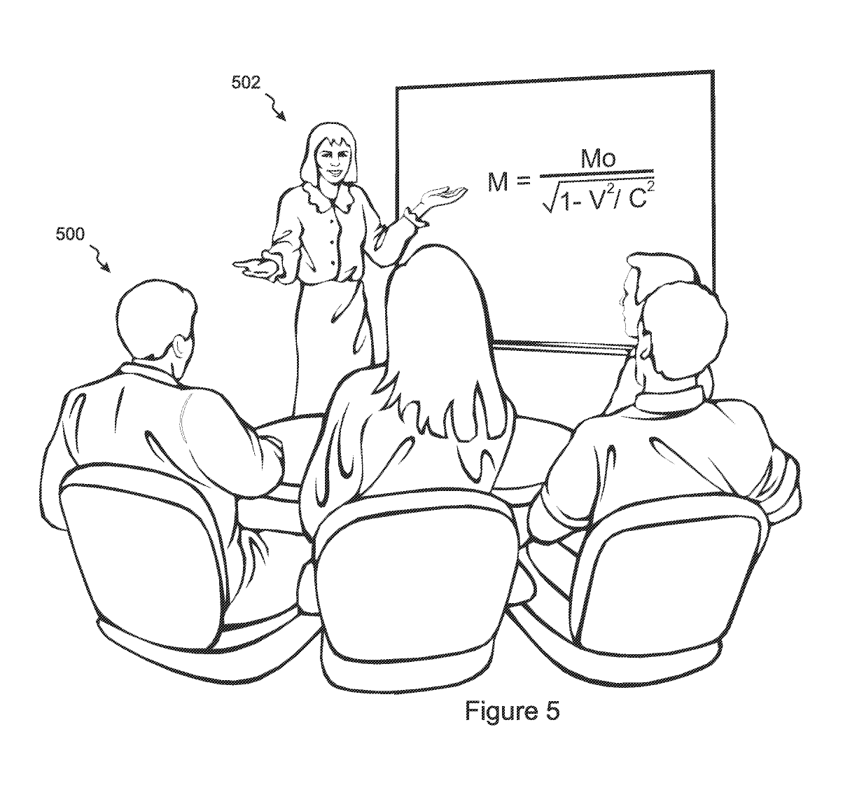

The purchase of services is also included in embodiments of the present invention. In FIG. 5, an avatar 500 is attending a lecture presented to a group of avatars by a teacher 502 within the virtual reality world. The user thereby receives the educational benefit of the lecture, and the avatar 500 receives educational status and/or certifications which will increase the status of the avatar 500 and enable the avatar 500 to seek certain types of employment and/or other experiences which are only available to avatars having those qualifications.

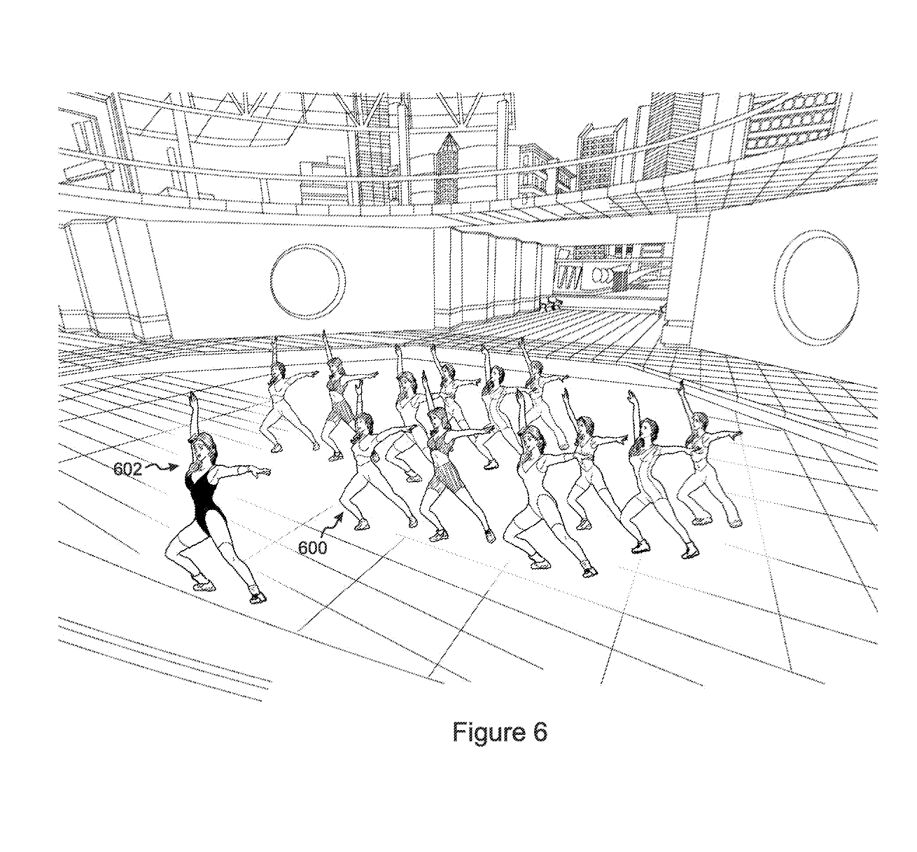

FIG. 6 illustrates an avatar in a preferred embodiment receiving physical fitness instruction from a physical trainer 602. In this embodiment, the avatar 600 will suffer a decline in health and stamina if it does not engage in exercise and other healthy practices. In some embodiments, while the avatar 600 is receiving physical fitness training, the avatar's user can also exercise in the real world by following the instructions provided by the virtual fitness instructor 602. And in some embodiments, purchase of physical fitness training for the avatar results in a voucher being provided to the user which can be exchanged for real-world fitness training at a real-world fitness center.

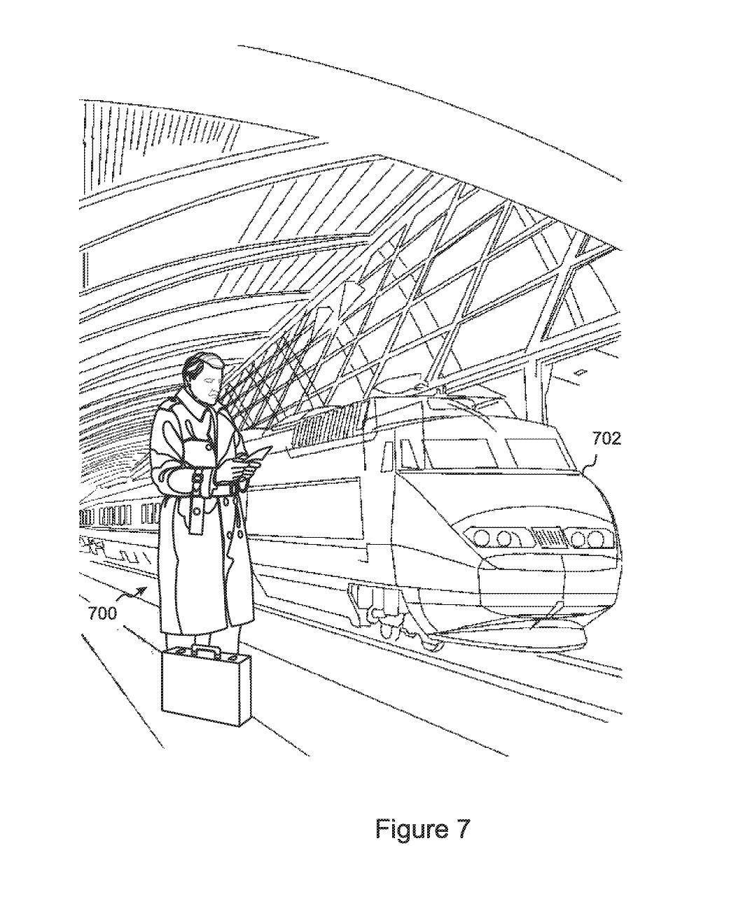

In various embodiments of the present invention avatars are able to purchase travel arrangements and thereby to visit locations and have experiences which would not otherwise be available. In FIG. 7, an avatar 700 has purchased a train ticket, and is waiting to board a train 702 which will take it to a virtual location which is not otherwise available to the avatar 700. Purchasing the train ticket has also caused a real-world train ticket to be provided to the user of the avatar.

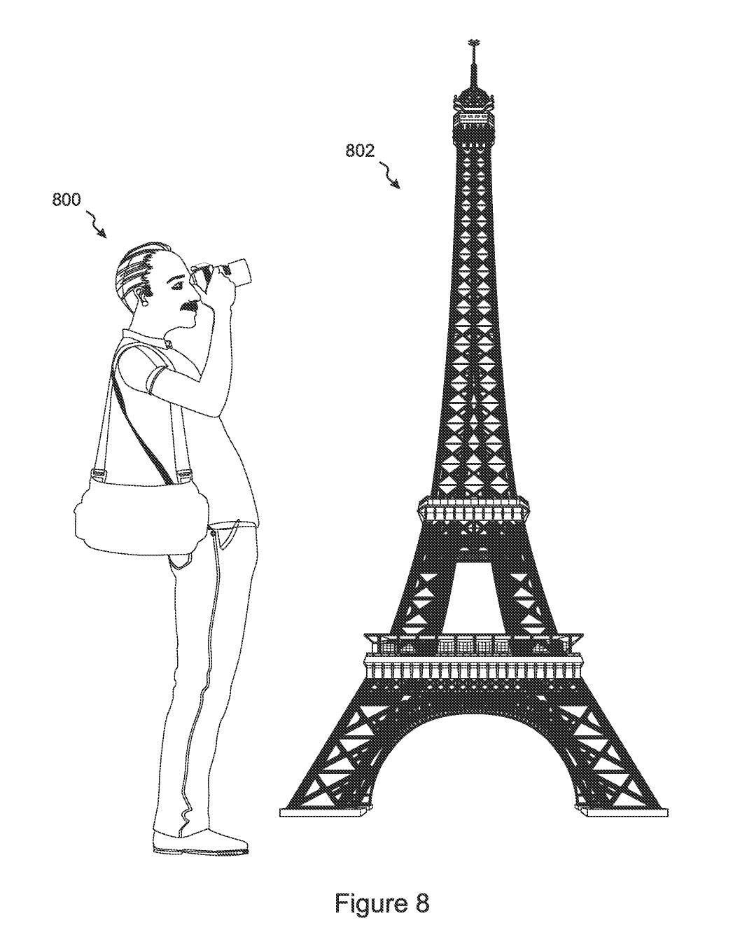

With reference to FIG. 8, in some embodiments locations in the virtual reality world correspond with real locations in the real world. In FIG. 8, a user has used an embodiment of the present invention to purchase an airline ticket to Paris, thereby also transporting his or her avatar 800 to a corresponding virtual Paris 802 within the virtual reality world. By making the airline ticket purchase through the present invention, rather than by conventional means, the user has thereby arranged for the avatar to have a linked and parallel experience, so that the user feels as if the avatar 800 has accompanied him or her on vacation.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. An ecommerce system comprising media containing software which is operable on a server computer and accessible to a user through a computer network, the software being able to provide to the user a simulation of a virtual reality world, the virtual reality world including:
an avatar under control of the user; and
a virtual product available for purchase by the avatar within the virtual reality world,
purchase of the virtual product by the avatar also causing delivery of a linked real product to the user, the virtual product being at least a virtual representation of the linked real product.

2. The ecommerce system of claim 1, wherein purchase of the virtual product by the avatar provides a benefit to the avatar, and the resulting delivery of the real product to the user provides a linked, corresponding benefit to the user.

3. The ecommerce system of claim 1, wherein the virtual product is a tangible good, which is a virtual representation of the real product.

4. The ecommerce system of claim 3, wherein the real product is shipped to the user after the virtual product is purchased by the avatar.

5. The ecommerce system of claim 3, wherein purchase of the virtual product by the avatar causes a voucher to be provided to the user, the voucher being redeemable for the real product.

6. The ecommerce system of claim 1, wherein the virtual product enhances a status of the avatar, and the real product enhances a status of the user.

7. The ecommerce system of claim 1, wherein the virtual product is a service which is delivered simultaneously through the virtual reality world to both the avatar and the user.

8. The ecommerce system of claim 7, wherein the service includes at least one of:
a movie;
a dramatic performance;
a concert;
a fitness training session; and
a lecture.

9. The ecommerce system of claim 1, wherein the avatar receives increased health due to purchase of the virtual product, and the user receives increased health due to consumption of the real product.

10. The ecommerce system of claim 1, wherein the avatar receives increased stamina due to the purchase of the virtual product, and the user receives increased stamina due to consumption of the real product.

11. The ecommerce system of claim 1, wherein the avatar receives increased employment qualifications due to the purchase of the virtual product, and the user receives increased employment qualifications due to consumption of the real product.

12. The ecommerce system of claim 1, wherein the virtual product includes transportation to a virtual location within the virtual reality world, and the real product includes transportation to a real location in the real world.

13. The ecommerce system of claim 12, wherein the virtual location is a virtual representation of the real location.

14. The ecommerce system of claim 1, wherein the virtual product meets a virtual need of the avatar, the virtual need corresponding to a real need of the user which is met by the real product.
